(19) United States
(12) Patent Application Publication
(10) Pub. No.: US 2003/0002074 A1
(43) Pub. Date: Jan. 2, 2003

(54) Printer capable of managing a consumable printing material

(75) Inventor: Tsuyoshi Miyano, San Jose, CA (US)

Correspondence Address: BEYER WEAVER & THOMAS LLP, P.O. BOX 778, BERKELEY, CA, 94704-0778, US

(73) Assignee: ALPS Electric Co., Ltd

(21) Appl. No.: 09/898,873

(22) Filed: Jul. 2, 2001

(51) Int. Cl. B41F 1/00; G06F 15/00; H04N 1/00

(52) U.S. Cl. 358/1.15; 358/1.14; 358/402

(57) ABSTRACT

A printer capable of managing a consumable printing product is described. The printer includes a printing mechanism, a sensor, a network interface, and a controller. The printing mechanism is arranged to utilize a consumable product during printing. The sensor generates a status signal indicative of a status of the printer. The network interface is operable to couple the printer to a network. The controller is operable to send an e-mail message to a maintenance computer through the network in response to the status signal.

### BACKGROUND OF THE INVENTION

The present invention relates to printers, and more specifically, to apparatus and methods for managing consumable materials used by printers.

Printers are used for printing various documents. Printers create images on a printing medium (e.g., paper) by using a consumable printing material (referred to herein as a consumable printing product) that will vary depending on the kind of printing mechanisms is used. For example, a thermal transfer printer uses an ink ribbon as the consumable printing product. An ink jet printer uses printing ink in an ink cartridge. An electrophotographic printer (or a “laser printer”) uses toner in a toner cartridge.

In order to insure that a printer has the ink, toner, ribbon or other required consumable printing materials available at all times, it is important that someone monitors the printer and/or the consumable material inventory to insure that sufficient materials are on hand as needed. In a home or small office, this is often not a problem since one or more individuals may assume that responsibility. However, in larger organizations, and environments where printers are provided at locations that are remote or physically separated from the person responsible for their maintenance, this can be more difficult. A current barrier to providing consumable products efficiently is the costs and complexity of monitoring the status of each printer. That is, monitoring the level or amount of the consumable product that remains available for use in each remote printer. If a maintenance provider has a large number (e.g. thousands) of printers to take care of, it is often not practical to poll the various printers frequently in order to check their status and then react accordingly in a timely manner. In some situations, the proper response may be to deliver additional supplies of the consumable material to the needy printer(s). In other situations, it may be necessary to purchase and/or notify a customer that it is time to purchase, additional quantities of the consumable product. Thus, in order to permit printer maintenance providers to better service their printers, it would be desirable to be able to efficiently monitor the status of consumable products used in remotely located printers.

In view of these and other issues, it would be desirable to have a technique allowing a printer to notify a maintenance provider's server of the status, level or available amount of the printer's consumable printing product.

### SUMMARY OF THE INVENTION

According to various embodiments of the present invention, a printer has a sensor for sensing the status of a consumable printing product, such as an ink ribbon cartridge, an ink cartridge, a toner cartridge, and the like. When the sensor detects a shortage of the consumable printing product, the printer sends an e-mail message to a maintenance computer to notify the maintenance provider of the situation. Thus, the maintenance provider can perform necessary steps to render services for the consumable product.

One aspect of the present invention provides a printer capable of notifying a server of status of a consumable product used by the printer. The printer includes a printing mechanism, a sensor that generates a status signal indicative of a status of the printer, and a controller. The controller is operable to send an e-mail message to a maintenance computer through the network in response to the status signal.

Another aspect of the present invention provides a method for providing status information of a printer. The method includes generating a status signal indicative of a status of the printer, generating an e-mail message indicative of the status of the printer based on the status signal, and sending an e-mail message to a maintenance computer through a network.

A further understanding of the nature and advantages of the present invention may be realized by reference to the remaining portions of the specification and the drawings.

### BRIEF DESCRIPTION OF THE DRAWINGS

FIG. 1 is a block diagram of a system including a printer coupled to a server according to a specific embodiment of the present invention.

FIG. 2A is a diagram of a data packet for an e-mail message used for a specific embodiment of the present invention.

FIG. 2B is a diagram of a data packet for an e-mail message used for another specific embodiment of the present invention.

FIG. 3 is a flowchart of a method for sending an e-mail message indicating the status of the printer for use with a specific embodiment of the present invention.

FIG. 4 is a block diagram of a typical computer system in accordance with an embodiment of the present invention.

### DETAILED DESCRIPTION OF SPECIFIC EMBODIMENTS

Various embodiments of the present invention will now be described in detail with reference to the drawings, wherein like elements are referred to with like reference labels throughout.

Various embodiments of the present invention enable a maintenance provider to monitor the status of a remote printer connected to a maintenance server through a network. In one specific context, such a maintenance provider may be a third party maintenance provider which sells various consumable printing materials to a large number of printer users. The maintenance provider monitors the status of the consumable printing materials of their printers by receiving e-mail messages sent from printers which need new consumable printing materials, and distributes the necessary consumable products to the printer user. The status of the printer may be, for example, any combination of the remaining amount of various consumable printing materials (e.g., ink ribbons, ink, and toner) distributed as consumable printing products (e.g., ink ribbon cartridges, ink cartridges, and toner cartridges), and/or the error status of the printer.

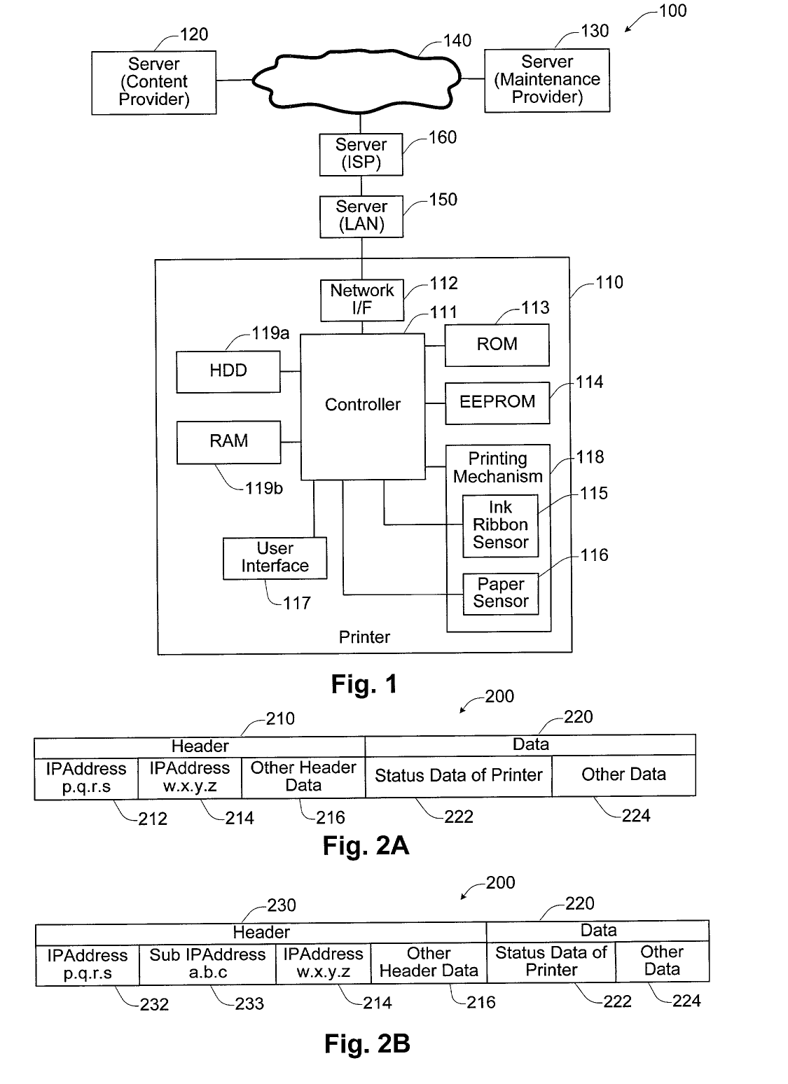

FIG. 1 is a block diagram of a system 100 including a printer 110 coupled to a server according to a specific embodiment of the present invention. The system 100 includes the printer 110, and a content server 120, and a maintenance server 130, each of which is connected to the network 140. The printer 110 is connected to the network 140 through a LAN server 150 for managing a LAN (Local Area Network) and an ISP server 160 for an ISP (Internet Service Provider). The printer 110 communicates with the content server 120 in order to retrieve various data.

A user using the printer 110 and the LAN server 150 has an access to the content server 120, which is maintained by, for example, a content provider. The user also has an access to the maintenance server 130, which is maintained by a maintenance provider. In some circumstances, one of the objectives of the maintenance provider is to provide the user with consumable printing products such as ink ribbons, printing ink cartridges, and toner cartridges with little lead time to supply these products to the user. In order to achieve this objective, the printer 110 is capable of sending to the maintenance provider necessary information regarding a consumable printing product used for the printer 110 and/or a status of the printer 110, thereby, for example, sending purchase information to the user, preparing shipment of the consumable printing product, contacting maintenance staff for servicing the printer 110, and the like.

The printer 110 includes a controller 111, a network interface 112, a ROM (Read-Only Memory) 113, an EEPROM (Electrically Erasable Programmable Read-Only Memory) 114, an ink ribbon sensor 115, a paper sensor 116, a user interface 117, a printing mechanism 118, an HDD (Hard Disk Drive) 119a, and a RAM (Random Access Memory) 119b. The controller 111 controls various functions of components included in the printer 110, communicates with an external device by exchanging data (e.g., e-mail messages) through the network interface 112, and processes the retrieved data. The controller 111 is typically implemented by a microprocessor unit, and may be associated other control circuitry including one or more microprocessor units and/or one or more associated integrated circuits.

The network interface 112 connects the controller 111 to the LAN server 150 using, for example, the Ethernet protocol. The LAN server 150 communicates with the ISP server 160 using TCP/IP (Transport Control Protocol/Internet Protocol). The ISP server 160 communicates with the content provider server 120 using TCP/IP. The network connection between the network interface 112 and the servers 150 and 160 includes wired and/or wireless connections. It should be understood that the printer 110 and the content server 120 may communicate through one or more network devices including PCs (Personal Computers), servers, routers, Internet appliances, terminal adapters, and the like.

In a specific embodiment, the ROM 113 stores various parameters or data associated with the printer 110 and/or controller 111. For example, the ROM 113 stores identification data associated with the printer 110. The EEPROM 114 may store, for example, an IP address of the printer 110. Various embodiments of the present invention may use other types of a suitable storage medium which serves as the EEPROM 114, including a ROM (read only memory), a RAM (random access memory), a hard disk drive, and other magnetic, optical or magneto-optical data storage devices.

According to one specific embodiment of the present invention, the printing mechanism 118 includes two separate sensors for sensing the status of the printer 110. In this specific embodiment, the printer 110 has the ink ribbon sensor 115 and the paper sensor 116. The ink ribbon sensor 115 senses low or no amount remaining in the ink ribbon used for the printer 110. The ink ribbon sensor 115 may be a set of an LED (Light Emitting Diode) and a phototransistor which is capable of detecting the end of the ink ribbon in an ink ribbon cartridge. The ink ribbon sensor 115 generates a status signal indicative of the end of the ink ribbon, and outputs the status signal to the controller 111. The paper sensor 116 senses paper jamming in the printer 110. In a specific embodiment, the paper sensor 116 is a set of an LED and a phototransistor which is capable of detecting a sheet of paper remaining in the paper path through which the paper is forwarded.

However it should be understood that one of the ink ribbon sensor 115 and the paper sensor 116 may be omitted, and that the printer 110 may include any number of various sensors to monitor its status. A sensor for generating a status signal indicative of the printer 110 corresponds to the consumable printing used for the printer 110. The consumable printing product may be one of an ink ribbon for a thermal transfer printer, a printing ink cartridge for a ink jet printer, a toner cartridge for an electrophotographic printer (or a “laser” printer), and the like. The status of the printer 110 includes low or no remaining amount of the consumable printing product, paper jamming, and other errors caused internally or externally by mechanical or electrical problems of the printer 110. Thus, other kinds of sensors corresponding to a consumable printing product and an error necessary to be notified may be used instead of the ink ribbon sensor 115 and the paper sensor 116.

For example, if the printing mechanism 118 includes a thermal transfer mechanism, then the consumable product would be an ink ribbon, and an optical sensor including an LED and a phototransistor is used for the ink ribbon sensor 115. Alternatively, when the printing mechanism 118 includes an ink jet mechanism, the consumable product would be printing ink in an ink cartridge, and a sensor with electrodes in the ink cartridge is used for the ink ribbon sensor 115. The sensor for the printing ink senses electrically the volume of the remaining printing ink utilizing variation in the resistance of the printing ink. Similarly, when the printing mechanism 118 includes an electrophotographic printing engine (or a laser printing engine), the consumable product would be toner particles in a toner cartridge, and a sensor with electrodes in the toner cartridge is used for the ink ribbon sensor 115. The sensor for the toner senses electrically the volume of the remaining toner utilizing variation in the resistance of the toner.

In a specific embodiment, when the printer 110 runs short of an ink ribbon, the ink ribbon sensor 115 senses the shortage of the ink ribbon, generates a status signal indicative of the printer status, i.e., no ink ribbon, and outputs the status signal to the controller 111. In response to the status signal, the controller 111 generates an e-mail message containing data representing the status of the printer 10, and sends the e-mail message to the maintenance server 130 via the network in server 150, the ISP server 160, and the network 140.

In a specific embodiment, the ink ribbon sensor 115 generates the status signal based on a remaining amount of the consumable product (e.g., the ink ribbon). In a further specific embodiment, the ink ribbon sensor 115 generates the status signal when there is no ink ribbon left for use. In another embodiment, the ink ribbon sensor 115 determines whether the remaining amount of the consumable product is less than a threshold value.

In the specific embodiment, the paper sensor 116 generates the status signal for the printer 110 indicative of an error status of the printer 110, i.e., paper jamming. However, it should be understood that the error status of the printer 110 includes various errors internally or externally caused to the printer 110 such as a communication error with an external device, a buffer full error, and the like. These errors are sensed any combination of one or more separate sensors like the paper sensor 116 and/or the controller 111. In this specification, a controller or microprocessor unit itself is treated as a “sensor” where the controller senses the error without a separate sensor. An example of such a case is when the controller senses an occurrence of a communication error based on an error flag on a signal line coupled with an interface circuitry.

The user interface 117 includes any suitable display device and/or input device. Such a display device includes, for example, any combination of an LED, an LCD (Liquid Crystal Display) panel and/or an LCD touch panel for presenting information retrieved from the controller 111 to the user. Such an input device includes a switch and/or an LCD touch panel for receiving the user's response to the information and outputting the information about the user's response to the controller 111. It will be understood that other types of interface circuitry and devices may be utilized to serve as the user interface 117.

According to the specific embodiment, the printing mechanism 118 includes any suitable printing mechanism. Such a printing mechanism includes, for example, a full-color, thermal transfer printing mechanism. However, it will be understood that the printing mechanism 118 may employ an ink jet mechanism or an electrophotographic mechanism. Typically, the printing mechanism 118 prints an image for the document of value requested by the user on a print medium including paper, plastic material, thin metal material, and the like. The printing mechanism 118 may utilize a monochrome printing scheme, and other printing methods using special inks including UV (Ultraviolet) inks and/or magnetic inks in addition to the full-color printing scheme.

The HDD 119a and the RAM 119b store various software program, instructions and data necessary for operating the controller 111 and other associated components of the printer 110.

The LAN server 150 communicates with the printer 110 by any suitable communications protocol, as for example, the Ethernet protocol. The LAN server 150 may be connected to other external devices, such as a PC (personal computer), a printer server, a router, and the like. The connection between the printer 110 and the LAN server 150 may be combination of wired and/or wireless coupling using various data transmission medium such as twisted pair cables, baseband coaxial cables, broadband coaxial cables, optical fibers, radio frequency waves, infrared waves, and the like.

The ISP server 160, which is provided by, for example, an ISP, communicates with the LAN server 150 and the network 140 typically by the TCP/IP protocol. The content server 120 provided by a content provider also communicates with the network 140 typically by the TCP/IP protocol. The network 140 may be any combination of networks including the Internet, a LAN, a MAN (Metropolitan Area Network), a WAN (Wide Area Network), and any number of other private networks referred to as the “Intranets.” Such networks may be implemented with any number of hardware and software components, transmission media and network protocols. Any number of servers and/or network devices may be inserted between the LAN server 150 and the content server 120.

FIG. 2A is a diagram of a data packet for an e-mail message used for a specific embodiment of the present invention. According to the specific embodiment of the present invention, a data packet 200 sent from the printer 110 to the maintenance server 130 includes a header portion 210 and a data portion 220. The header portion 210 includes an IP address 212 (namely, four octets of “p.q.r.s”) representing the printer 110, an IP address 214 (namely, four octets of “w.x.y.z”) representing the server 120, and other header data 216. The IP address 212 may be assigned in any suitable manner in order to specify the printer 110.

The data portion 220 includes status data 222 of the printer 110, and other data 224. In a specific embodiment, the status data 222 includes data representing the remaining amount of the consumable product (e.g., the ink ribbon). In another specific embodiment, the status data 222 includes data representing an error status of the printer 110.

Alternatively, the printer 110 is specified by a combination of an IP address 232 (namely, four octets of “p.q.r.s”) and a sub IP address 233 (namely, three octets of “a.b.c”). FIG. 2B is a diagram of a data packet for an e-mail message used for another specific embodiment of the present invention. The data packet sent from the printer 110 to the maintenance server 130 includes a header portion 230 and the data portion 220. The header portion 230 includes the IP address 232 representing the LAN server 150 and the sub IP address 233 specifying the printer 110 among various devices connected locally to the LAN server 150. The sub IP address 233 may be assigned by any suitable mechanism. For example, the LAN server 150 may uniquely assign the sub IP address 233 (i.e., “a.b.c”) to the printer 110.

The maintenance provider monitoring the status of the printer 110 using the server 130 is capable of specifying the printer 110 which sends an e-mail message containing the status of the printer 110 based on the IP address 212, or the combination of the IP address 232 and the sub IP address 233.

In one specific embodiment, the network interface 112 sends the packet for the e-mail message shown in FIG. 2 in a Simple Mail Transfer Protocol format. However, other formats may be utilized to send the status data of the printer 110 to the maintenance server 130 via the network 140.

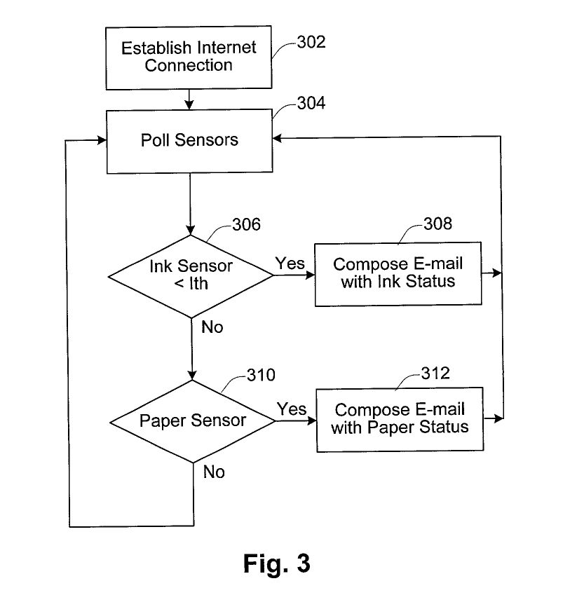

FIG. 3 is a flowchart of a method for sending an e-mail message indicating the status of the printer 110 for use with a specific embodiment of the present invention.

At 302, the printer 110 establishes a connection with the maintenance server 130. Of course, the nature of the connection may vary a great deal based on the nature of the network 140. By way of example, the connection may be established through an Intranet connection (via the servers 150 and 160 in the embodiment shown). Such a connection may further includes any other networks including the Internet, a LAN, a WAN, and the like. At 304, the controller 111 polls the ink ribbon sensor 115 and the paper sensor 116. At 306, if the ink ribbon sensor 115 indicates that a remaining amount of the ink ribbon is less than a threshold level of Ith (a non-minus value), then the process proceeds to 308.

At 308, the controller 111 composes an e-mail message 200 containing the status data 222 of the printer 110 in the data portion 220. The status data 222 in the email message 200 includes data indicating that the remaining amount of the ink ribbon is below the threshold level of Ith. When the ink ribbon sensor 115 which outputs a discrete value (e.g., “High” or “Low”) is used, the controller 111 at 306 simply monitors the value output from the ink ribbon sensor 115 without comparing to the threshold value of Ith. In other words, if the output of the ink ribbon sensor 115 is “High” representing no ink ribbon, then the process proceeds to 308. Otherwise, the process goes to 310.

If the determination at 306 is “No,” then the process proceeds to 310. At 310, the controller 111 checks an output signal from the paper sensor 116. If the signal output from the paper sensor 116 indicates that paper jamming occurred, then the process proceeds to 312, i.e., to the “Yes” node. At 312, the controller 111 composes an e-mail message 200 containing the status data 222 of the printer 110 in the data portion 220. The status data 222 in the e-mail message 200 in this case includes data indicating that the paper jamming occurred.

After operations at 308, 310 and 312, the process proceeds back to 304 for further polling. Thus, the printer 110 sends an e-mail message containing data indicating the printer status only when a situation which should be taken care of by the maintenance provider occurs (i.e., shortage of the consumable printing product, and other printer errors).

The functionality of the embodiments of the present invention can be implemented by any combination of software and/or hardware. For example, the embodiments can be implemented in an operating system (e.g., Windows NT) kernel, in a separate user process, in a library package bound into network applications, on a specially constructed machine, or on a network interface card. In one specific embodiment of the invention, the operations performed by the embodiments of the invention are partially implemented in server software. It is also partially implemented in client code on a device which is connected with the server via the network. Both components may be implemented in an operating system or in an application running on an operating system.

Embodiments of the present invention relate to an apparatus and a method for sending an e-mail message indicating the printer status to a maintenance provider as described in detail above. This apparatus may be specially constructed (or designed) for the required purposes, or it may be a general-purpose computer selectively activated or configured by a computer program stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method operations. The required architecture or structure for a variety of these machines will appear from the description given below.

Such a programmable machine may be a network device designed to handle network traffic, such as, for example, a network sever. Such network devices may have multiple network interfaces including frame relays or ISDN interfaces, for example. In an alternative embodiment, the item substitution technique of this invention may be implemented on a general-purpose network host machine such as a personal computer or workstation. Further, any or all of the functionality of the invention may be at least partially implemented on a card (e.g., an interface card) for a network device or a general-purpose computing device.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as mini disks, floptical disks; and hardware devices that are specially configured to store and perform program instructions, such as ROM (read-only memory) and RAM (random access memory). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

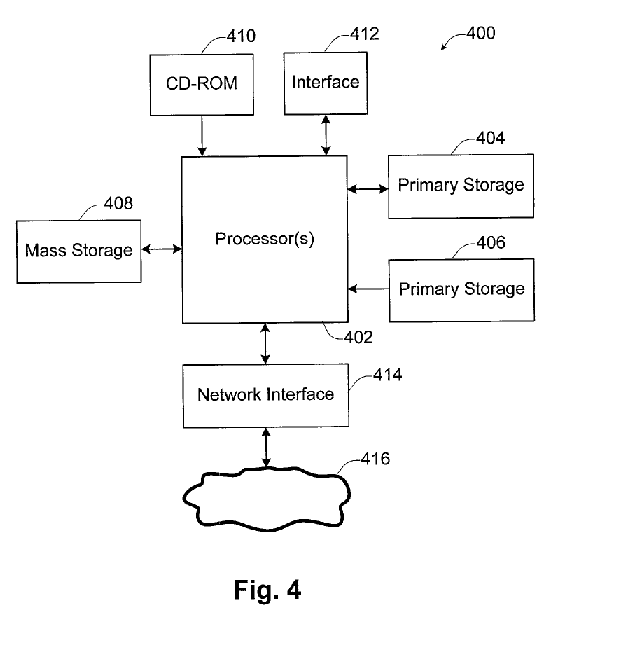

FIG. 4 is a block diagram of a typical computer system in accordance with an embodiment of the present invention. The computer system 400 includes any number of processors 402 (also referred to as controllers, CPUs, or central processing units) that are coupled to storage devices including primary storage 404 (typically a RAM), primary storage 406 (typically a ROM). As is well known in the art, the primary storage 404 acts to transfer data and instructions bi-directionally to the CPU and primary storage 406 is used typically to transfer data and instructions in a uni-directional manner. Both of these primary storage devices may include any suitable type of the computer-readable media described above. A mass storage device 408 is also coupled bi-directionally to CPU 402 and provides additional data storage capacity and may include any of the computer-readable media described above. The mass storage device 408 may be used to store programs, data and the like and is typically a secondary storage medium such as a hard disk that is slower than primary storage. It will be appreciated that the information retained within the mass storage device 408, may, in appropriate cases, be incorporated in standard fashion as part of primary storage 404 as virtual memory. A specific mass storage device such as a CD-ROM 410 may also pass data uni-directionally to the CPU 402.

CPU 402 is also coupled to an interface 412 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to a computer or telecommunications network 416 including the Internet and/or an Intranet (typically a LAN, or local area network) using a network interface as shown generally at 414. With such a network interface, it is contemplated that the CPU 402 might receive information from the network 416, or might output information to the network in the course of performing the above-described method operations. The above-described devices and materials will be familiar to those of skill in the computer hardware and software arts.

The network interface 414 is typically provided as an interface card (sometimes referred to as a “line card”). Generally, it controls the sending and receiving of data packets over the network and sometimes support other peripherals used with the computer system 400. The network interface 414 may be one of Ethernet interfaces, frame relay interfaces, cable interfaces, DSL (Digital Subscriber Line) interfaces, token ring interfaces, and the like. In addition, various very high-speed interfaces may be provided such as fast Ethernet interfaces, Gigabit Ethernet interfaces, ATM (Asynchronous Transfer Mode) interfaces, HSSIs (High-Speed Serial Interfaces), FDDIs (Fiber Distributed Data Interface) and the like. Generally, these interfaces may include ports appropriate for communication with the appropriate media. In some cases, they may also include an independent system including a processor and system memory.

The CPU 402 may take various forms. It may include one or more general purpose microprocessors that are selectively configured or reconfigured to implement the functions described herein. Or it may include one or more specially designed processors or microcontrollers that contain logic and/or circuitry for implementing the functions described herein. Any of the logical devices serving as CPU 402 may be designed as general purpose microprocessors, microcontrollers (sometimes simply referred to as “controllers”), ASICs (application specific integrated circuits), DSPs (digital signal processors), PLDs (programmable logic devices), FPGAs (field programmable gate arrays), and the like. They may execute instructions under the control of the hardware, firmware, software, reconfigurable hardware, combinations of these, etc.

The hardware elements described above may be configured (usually temporarily) to act as one or more software modules for performing the operations of this invention. For example, separate modules may be created from program instructions for performing the functionality of the embodiments according to the present invention as described above. The components shown in FIG. 4 are coupled separately, but any or all of them may be coupled through a common system bus (e.g., a PCI bus).

Although only a few embodiments of the present invention have been described in detail, it should be understood that the present invention may be embodied in many other specific forms without departing from the spirit or scope of the invention. For example, the illustrated embodiments have been described primarily in the context of a maintenance server run by a maintenance provider, it should be appreciated that various servers run by other entity or person may monitor the status of a remote printer connected to the server via a network. In other words, the scheme sending an e-mail message containing the status of the printer may be utilized by various servers for other purposes. For example, a server can collect information about frequency with which the printer needs a new consumable printing product so that a server can use the information for advertising, marketing, or user support purposes other than maintenance purposes.

Therefore, it should be apparent that the above described embodiments are to be considered as illustrative and not restrictive, and the invention is not to be limited to the details given herein, but may be modified within the scope of the appended claims.

What is claimed is:

1. A printer comprising:
a printing mechanism, the printing mechanism being arranged to utilize a consumable product during printing;
a sensor that generates a status signal indicative of a status of the printer;
a network interface suitable for coupling the printer to a network; and
a controller operable to send an e-mail message to a maintenance computer through the network in response to the status signal.

2. The printer of claim 1, wherein the sensor is operable to generate the status signal based on a remaining amount of the consumable product.

3. The printer of claim 2, wherein the sensor is operable to generate the status signal based on whether the remaining amount of the consumable product is less than a threshold value.

4. The printer of claim 3, wherein the consumable product is an ink ribbon, and the printing mechanism includes a thermal transfer mechanism.

5. The printer of claim 3, wherein the consumable product is printing ink, and the printing mechanism includes an ink jet mechanism.

6. The printer of claim 3, wherein the consumable product is toner, and the printing mechanism includes an electrophotographic mechanism.

7. The printer of claim 1, wherein the sensor is operable to generate the status signal based on an error status of the printer.

8. The printer of claim 1, wherein the controller is operable to cause the network interface to send the e-mail message in a Simple Mail Transfer Protocol format.

9. The printer of claim 8, wherein the controller is operable to insert consumable product data representing the remaining amount of the consumable product into a data portion of the e-mail message.

10. The printer of claim 8, wherein the controller is operable to insert printer error data representing the error status of the printer into a data portion of the e-mail message.

11. A printer comprising:
means for printing, the means for printing being arranged to utilize a consumable product during printing;
means for generating a status signal indicative of a status of the consumable product;
means for coupling the printer to a network; and
means for sending an e-mail message to a maintenance computer through the network in response to the status signal.

12. A method for providing status information of a printer, comprising:
generating a status signal indicative of a status of the printer;
generating an e-mail message indicative of the status of the printer based on the status signal; and
sending an e-mail message to a maintenance computer through a network.

13. The method of claim 12, wherein the status signal is generated based on a remaining amount of a consumable product used for the printer.

14. The method of claim 13, wherein the status signal is generated based on whether the remaining amount of the consumable product is equal to or less than a threshold value.

15. The method of claim 14, wherein the consumable product is an ink ribbon, and the printer includes a thermal transfer mechanism.

16. The method of claim 14, wherein the consumable product is printing ink, and the printer includes an ink jet mechanism.

17. The method of claim 14, wherein the consumable product is toner, and the printer includes an electrophotographic mechanism.

18. The method of claim 12, wherein the status signal is generated based on an error status of the printer.

19. The method of claim 12, wherein the controller is operable to cause the network interface to send the e-mail message in a Simple Mail Transfer Protocol format.

20. The method of claim 19, wherein consumable product data representing the status of the consumable product is inserted into a data portion of the e-mail message.

21. The method of claim 19, wherein printer error data representing the error status of the printer is inserted into a data portion of the e-mail message.
